(19) United States
(12) Patent Application Publication
(10) Pub. No.: US 2016/0065854 A1
(43) Pub. Date: Mar. 3, 2016

(54) OFFSET CANCELLATION APPARATUS AND VOICE COIL MOTOR DRIVER INCLUDING THE SAME

(71) Applicant: Samsung Electro-Mechanics Co., Ltd., Suwon-Si (KR)

(72) Inventor: Kyung Uk KIM, Suwon-Si (KR)

(73) Assignee: SAMSUNG ELECTRO-MECHANICS CO., LTD., Suwon-Si (KR)

(21) Appl. No.: 14/838,739

(22) Filed: Aug. 28, 2015

(30) Foreign Application Priority Data
Aug. 28, 2014 (KR) 10-2014-0113244

(51) Int. Cl. H04N 5/232

(52) U.S. Cl. CPC H04N 5/23258

(57) ABSTRACT

There is provided an offset cancellation apparatus including: a power amplifier forcibly generating an offset; a replica amplifier, which is the same replica amplifier as the power amplifier, having a non-inverting input terminal and an inverting input terminal connected to a non-inverting input terminal and an inverting input terminal, respectively, of the power amplifier and outputting an offset compensation determining signal; and an offset compensating unit applying an offset compensating current to the power amplifier and the replica amplifier based on the offset compensation determining signal. According to the offset cancellation apparatus, whether or not the offset is compensated may be accurately determined and additional switches for sensing the offset are not required, and since the same replica amplifier as the power amplifier is used, a configuration is simple and an operation for canceling the offset is simple, thereby making it possible to rapidly cancel the offset.

### CROSS-REFERENCE TO RELATED APPLICATION

This application claims the benefit of Korean Patent Application No.

10-2014-0113244, filed on Aug. 28, 2014, entitled “Offset Cancellation Apparatus and Voice Coil Motor Driver Including the Same” which is hereby incorporated by reference in its entirety into this application.

### BACKGROUND

The present disclosure relates to an offset cancellation apparatus and a voice coil motor driver including the same.

A voice coil motor (VCM) driver for optical Image stabilization (OIS) is to correct a hand-shake. A principle of correcting the hand-shake is that a position and strength of the hand-shake is determined by a gyro sensor and the determined position and strength are reflected to a lens, wherein the VCM driver for OIS controls a current flowing in the VCM by detecting a current position of a lens barrel by a hall sensor and detecting a degree of hand-shake of the gyro sensor and moves the lens barrel to a direction which is opposite to a direction of the hand-shake, so as to correct the hand-shake.

In general, the VCM driver includes a power amplifier receiving an output of a current digital-analog converter converting digital codes of a plurality of bit output from a proportional-integral-derivative (PID) controller (not shown) into an analog current signal and outputting a VCM driving signal.

However, the power amplifier generally includes an operational amplifier configuring a differential amplifier by using the same transistors at an input stage, wherein a predetermined offset voltage occurs between input terminals of the operational amplifier due to deviation between the transistors included in the input stage, that is, a difference of characteristics at the time of manufacturing a semiconductor.

In the case in which the offset voltage occurs in the power amplifier, an offset current also occurs in a current flowing in the VCM. Therefore, because offset error occurs in the current flowing in the VCM, error may also occur in a movement distance of a camera lens.

Patent Document disclosed in the following Related Art Document relates to an offset auto calibration apparatus and method capable of allowing an offset originally possessed by a system to be automatically adjusted to an allowable offset, wherein if the system is enabled, a positive offset current is applied to an error amplifier so that a positive offset occurs and a negative offset current is then applied to the error amplifier so that a sensed offset current becomes an offset current within an allowable range by comparing the sensed offset current with the offset current within the allowable range, thereby making it possible to allow the offset current originally possessed by the system to be automatically adjusted to the allowable offset current.

### Related Art Document

[Patent Document]

(Patent Document 1) KR10-1135118 B1

### SUMMARY

An aspect of the present disclosure may provide an offset cancellation apparatus capable of having a simple configuration and rapidly canceling an offset by using the same replica amplifier as a power amplifier.

An aspect of the present disclosure may also provide a voice coil motor driver including an offset cancellation apparatus capable of having a simple configuration and rapidly canceling an offset by using the same replica amplifier as a power amplifier.

According to an aspect of the present disclosure, an offset cancellation apparatus may include: a power amplifier forcibly generating an offset; a replica amplifier, which is the same replica amplifier as the power amplifier, having a non-inverting input terminal and an inverting input terminal connected to a non-inverting input terminal and an inverting input terminal, respectively, of the power amplifier and outputting an offset compensation determining signal; and an offset compensating unit applying an offset compensating current to the power amplifier and the replica amplifier based on the offset compensation determining signal.

A ratio of a width and a length of a gate of a transistor connected to the inverting input terminal of each of the power amplifier and the replica amplifier may be different from a ratio of a width and a length of a gate of a transistor connected to the non-inverting input terminal in order to forcibly generate the offset.

The offset compensating unit may apply an offset compensating current which is gradually increased to the transistor connected to the non-inverting input terminal of the input stage of each of the power amplifier and the replica amplifier and in the case in which the offset compensating current is increased, such that the voltage of the gate of the transistor connected to the non-inverting input terminal of the input stage of the replica amplifier is the voltage or less of the gate of the transistor connected to the inverting input terminal, the offset compensation determining signal may be changed from the “high” level to the “low” level.

The time point in which the voltage level of the offset compensation determining signal is changed from an initial “high” level to a “low” level may be determined as a time point in which the offset voltage generated from the power amplifier is compensated and canceled.

In the case in which the offset compensation determining signal is changed from the “high” level to the “low” level, the offset compensating unit may cancel the offset of the power amplifier by intactly maintaining a current amount of the offset compensating current of the time point in which the offset compensation determining signal is changed from the “high” level to the “low” level.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view showing a voice coil motor driver including an offset cancellation apparatus according to an exemplary embodiment of the present disclosure;

FIG. 2 is a detailed circuit diagram of a power amplifier and a replica amplifier shown in FIG. 1;

FIG. 3 is a detailed circuit diagram of a 7 bit digital-to-analog converter shown in FIG. 1;

FIG. 4 is a timing diagram for describing an operation of an offset cancellation apparatus according to an exemplary embodiment of the present disclosure; and

FIG. 5 is a flow chart for describing an offset cancellation method according to an exemplary embodiment of the present disclosure.

### DETAILED DESCRIPTION

The objects, features and advantages of the present disclosure will be more clearly understood from the following detailed description of the exemplary embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present disclosure, when it is determined that the detailed description of the related art would obscure the gist of the present disclosure, the description thereof will be omitted.

Hereinafter, exemplary embodiments of the present disclosure will be described in detail with reference to the accompanying drawings.

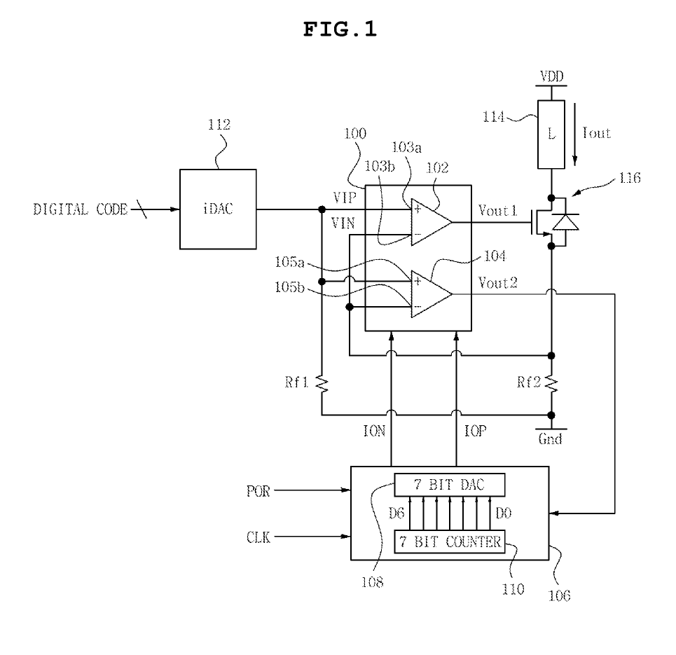

FIG. 1 is a view showing a voice coil motor driver including an offset cancellation apparatus according to an exemplary embodiment of the present disclosure.

A voice coil motor driver including an offset cancellation apparatus according to an exemplary embodiment of the present disclosure shown in FIG. 1 includes a power amplifier 102 outputting a voice coil motor driving signal Vout1 by receiving a signal output from a current digital-to-analog converter 112 and forcibly generating an offset, an input resistor Rf1 connected between a non-inverting input terminal 103a of the power amplifier 102 and a ground, a replica amplifier 104, which is the same replica amplifier as the power amplifier 102, having a non-inverting input terminal 105a and an inverting input terminal 105b connected to the non-inverting input terminal 103a and an inverting input terminal 103b, respectively, of the power amplifier 102 and outputting an offset compensation determining signal Vout2, an offset compensating unit 106 applying a positive offset compensating current IOP to the power amplifier 102 and the replica amplifier 104 based on the offset compensation determining signal Vout2, a driver transistor 116 allowing a current lout to flow in a voice coil motor 114 depending on the output Vout1 of the power amplifier 102, and a feedback resistor Rf2 connected between the driver transistor 116 and the ground and applying a feedback voltage to the power amplifier 102.

The offset compensating unit 106 includes a 7 bit counter 110 in which a count bit ([D6:D0]), which is an output at a rising edge of a clock signal CLK at the time of power on is increased by 1 and a 7 bit digital-to-analog converter 108 outputting a positive offset compensating current IOP depending on a count bit output from the 7 bit counter 110.

In FIG. 1, the power amplifier 102, the replica amplifier 104, and the offset compensating unit 106 are an offset cancellation apparatus according to an exemplary embodiment of the present disclosure.

In the offset cancellation apparatus according to an exemplary embodiment of the present disclosure, the replica amplifier 104 is a replica amplifier having the same structure and characteristics as the power amplifier 102 in hardware. In order to forcibly generate the offset, input stages of the power amplifier 102 and the replica amplifier 104 include transistors having different ratios of widths and lengths of gates.

The replica amplifier 104 outputs the offset compensation determining signal Vout2 determining whether or not the offset is compensated and outputs the offset compensation determining signal Vout2 including a “high” or “low” level signal, which is a logic signal by comparing a voltage applied to a gate of a transistor connected to the non-inverting input terminal 105a of an input stage therein with a voltage applied to a gate of a transistor connected to the inverting input terminal 105b.

The offset compensating unit 106 gradually increases the positive offset compensating current IOP until a state of the offset compensation determining signal Vout2 output from the replica amplifier 104 is changed from a “high” level of an initial of power on to a “low” level, and applies the increased positive offset compensating current IOP to the power amplifier 102 and the replica amplifier 104.

In the case in which the offset compensation determining signal Vout2 output from the replica amplifier 104 is changed from the “high” level to the “low” level, the 7 bit counter 110 of the offset compensating unit 106 stops the counting and intactly maintains the count code ([D6:D0]) at a time point in which the offset compensating determining signal Vout2 is changed from the “high” level to the “low” level, so as to be output to the 7 bit digital-to-analog converter 108.

As the count code ([D6:D0]), which is an output of the 7 bit counter 110 is intactly maintained, the 7 bit digital-to-analog converter 108 intactly outputs the positive offset compensating current IOP at the time point in which the offset compensation determining signal Vout2 is changed from the “high” level to the “low” level, so as to be applied to the power amplifier 102 and the replica amplifier 104, thereby removing the offset occurring from the power amplifier 102.

A detailed description of an operation of an offset cancellation apparatus according to an exemplary embodiment of the present disclosure configured as described above will be provided below.

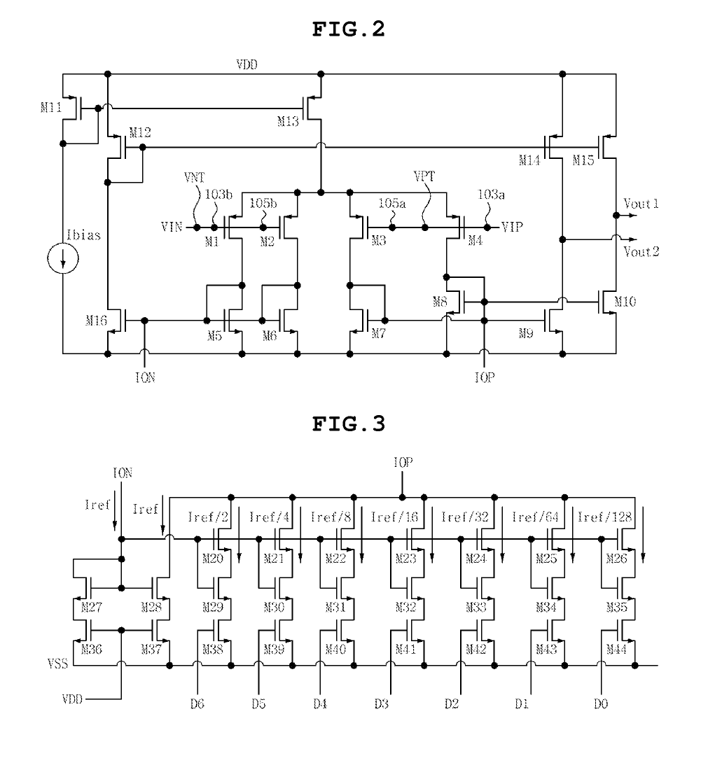

FIG. 2 is a detailed circuit diagram of the power amplifier 102 and the replica amplifier 104 within a block indicated by reference numeral of 100 in FIG. 1.

The power amplifier 102 and the replica amplifier 104 include transistors M1 to M16 and a bias current source Ibias.

An input stage of the power amplifier 102 includes the transistors M1, M4, M5, and M8, and an input stage of the replica amplifier 104 includes the transistors M2, M3, M6, and M7.

In addition, an output stage of the power amplifier 102 includes the transistors M10 and M15, and an output stage of the replica amplifier 104 includes the transistors M9 and M14.

A drain of the transistor M4 connected to the non-inverting input terminal 103a of the power amplifier 102 and a drain of the transistor M3 connected to the non-inverting input terminal 105a of the replica amplifier 104 are applied with the positive offset compensating current IOP output from the offset compensating unit 106.

In addition, a drain of the transistor M1 connected to the inverting input terminal 103b of the power amplifier 102 and a drain of the transistor M2 connected to the inverting input terminal 105b of the replica amplifier 104 are applied with a negative offset compensating current ION output from the offset compensating unit 106.

The replica amplifier 104, which is the same replica amplifier as the power amplifier 102, has the same structure and characteristics as the transistors configuring the power amplifier 102 and is implemented using the transistors having the same size.

When it is assumed that a voltage between a gate and a source of the transistors M1 and M2 is VGS1 and a voltage between a gate and a source of the transistors M3 and M4 is VGS2, the following Equations 1 and 2 are established.

VGS1=Vth+(2×i/(W/L)_{M2})^{1/2} [Equation 1]

VGS2=Vth+(2×i/(W/L)_{M3})^{1/2} [Equation 2]

Hereinabove, Vth represents a threshold voltage of the transistor, i represents a drain current, W represents a width of the gate of the transistor, and L represents a length of the gate of the transistor.

For convenience of explanation, effective mobility of charge carrier and capacitance of a gate oxide layer per unit area are not expressed in Equations 1 and 2.

The power amplifier 102 and the replica amplifier 104 are the same amplifier as each other, the transistor M1 and the transistor M2 are the transistor having the same size, and the transistor M3 and the transistor M4 are the transistor having the same size.

Therefore, a ratio ((W/L)_{M1}) of the width and the length of the gate of the transistor M1 is the same as a ratio ((W/L)_{M2}) of the width and the length of the gate of the transistor M2, and a ratio ((W/L)_{M3}) of the width and the length of the gate of the transistor M3 is the same as a ratio ((W/L)_{M4}) of the width and the length of the gate of the transistor M4.

A difference ΔVGS between the voltage VGS1 between the gate and the source of the transistor M2 and the voltage VGS2 between the gate and the source of the transistor M3 may be represented by the following Equation 3.

ΔVGS=VGS1−VGS2=(2×i)^{1/2}×((1/(W/L)_{M2})^{1/2}−(1/(W/L)_{M3})^{1/2}) [Equation 3]

If (W/L)_{M2}<(W/L)_{M3} is set, that is, the ratio ((W/L)_{M2}) of the width and the length of the gate of the transistor M2 is set to be smaller than the ratio ((W/L)_{M3}) of the width and the length of the gate of the transistor M3, VGS1>VGS2 is satisfied.

If the voltage VGS1 between the gate and the source of the transistor M2 is larger than the voltage VGS2 between the gate and the source of the transistor M3, a gate voltage VPT of the transistor M3 becomes larger than a gate voltage VNT of the transistor M2.

Meanwhile, since the count code ([D6:D0]), which is the output of the 7 bit counter 110 included in the offset compensating unit 106 becomes 0000000 at the initial at the time of the power on and all bits of the count code input to the 7 bit digital-to-analog converter 108 are 0, the negative offset compensating current ION and the positive offset compensating current IOP that are output from the 7 bit digital-to-analog converter 108 have the same value Iref as shown in FIG. 3.

Therefore, the VPT becomes larger than the VNT at the initial at the time of the power on (i.e., VPT>VNT), such that the offset compensation determining signal Vout2 output from the replica amplifier 104 becomes a “high” level state.

In the offset cancellation apparatus according to an exemplary embodiment of the present disclosure as described above, in order to forcibly generate the offset, by setting the ratio ((W/L)_{M2}) of the width and the length of the gate of the transistor M2 of the input stage of the replica amplifier 104 to be smaller than the ratio ((W/L)_{M3}) of the width and the length of the gate of the transistor M3, the VGS1 is allowed to be larger than the VGS2 (i.e., VGS1>VGS2), and the VPT is allowed to be larger than the VNT (i.e., VPT>VNT) by the offset which is forcibly generated at the initial at the time of the power on, such that the offset compensation determining signal Vout2 of the “high” level is output from the replica amplifier 104.

FIG. 3 is a detailed circuit diagram of the 7 bit digital-to-analog converter 108 shown in FIG. 1.

The 7 bit digital-to-analog converter 108 shown in FIG. 3 is configured by a current mirror circuit including transistors M20 to M44.

The 7 bit counter 110 starts the count from 0 at the initial at the time of the power on and outputs digital code ([D6:D0]) of 7 bits which is increased by 1.

The transistors M38 to M44 are switching transistors which are turned on or off depending on the digital code ([D6:D0]) of 7 bits, which is the output of the 7 bit counter 110.

In addition, the transistors M20 to M26 are the transistors having different ratios of widths and lengths of the gates. That is, the ratios of the widths and the lengths of the gates of the transistors M20 to M26 are 1/2, 1/4, 1/8, 1/16, 1/32, 1/64, and 1/128, respectively, when the ratio of the width and the length of the gate of the transistor M28 is 1, and an amount of current flowing through the transistors M20 to M26 is determined depending on the ratio of the width and the length of the gate.

Therefore, if the digital code ([D6:D0]) of 7 bits, which is the output of the 7 bit counter 110 is increased by 1, the positive offset compensating current IOP, which is the output of the 7 bit digital-to-analog converter 108 is also increased step by step.

For example, if D6:D0=1000000, the positive offset compensating current IOP is increased to IOP=Iref+Iref/2. The negative offset compensating current ION has a value Iref which is not changed and is fixed.

The digital code ([D6:D0]), which is the output of the 7 bit counter 110 at the time of the power on, is all in a “low” state, that is, 0 at the initial, and is increased by 1 at a rising edge (positive edge) of a clock signal CLK.

If the digital code ([D6:D0]) of 7 bits, which is the output of the 7 bit counter 110 is sequentially increased by 1, the 7 bit digital-to-analog converter 108 outputs the positive offset compensating current IOP which is gradually increased depending on the digital code ([D6:D0]), so as to be applied to the transistors M3 and M4 of the input stages of the replica amplifier 104 and the power amplifier 102.

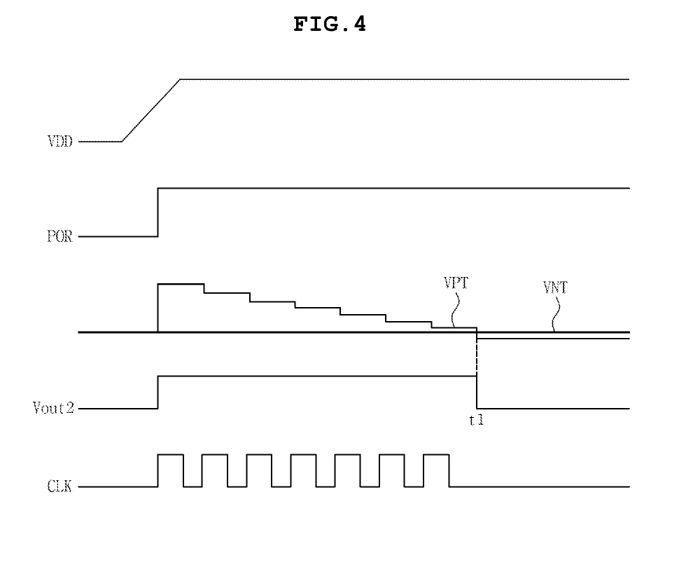

If the positive offset compensating current IOP applied to the drains of the transistors M3 and M4 is gradually increased, the voltage between the gate and the source of the transistors M3 and M4 is gradually increased, such that the voltage VPT applied to the gates of the transistors M3 and M4 are gradually decreased as shown in FIG. 4.

The count code ([D6:D0]), which is the output of the counter 110, is sequentially increased by 1 until the positive offset compensation determining signal Vout2, which is the output of the replica amplifier 104, becomes “low”.

That is, at the time point t1 in which the gate voltage VPT of the transistors M3 and M4 becomes smaller than the gate voltage VNT of the transistors M1 and M2, the positive offset compensation determining signal Vout2, which is the output of the replica amplifier 104 is changed from “high” to “low”.

The time point t1 in which the voltage level of the offset compensation determining signal Vout2 is changed from an initial “high” level to a “low” level may be determined as a time point in which the offset voltage is compensated and canceled.

Therefore, the counting of the 7 bit counter 110 is stopped at this time point t1, and the count code output from the 7 bit counter 110 maintains the same state until a power-on-reset (POR) signal again becomes the “low”, that is, a power on state is continuously maintained.

Therefore, the digital-to-analog converter 108 outputs the positive offset compensating current IOP depending on the count code output from the 7 bit counter 110, at the time point t1 in which the positive offset compensation determining signal Vout2 is changed from the “high” to the “low”.

If the positive offset compensating current IOP of the time point t1 in which the positive offset compensation determining signal Vout2 is changed from the “high” to the “low” is applied to the drain of the transistor M4 of the input stage of the power amplifier 102, the offset voltage due to characteristics difference between the transistors M1 and M4 occurring at the time of manufacturing a semiconductor is compensated and canceled.

Therefore, an influence of the offset current on the current lout flowing in the voice coil motor 114 is canceled by the offset voltage of the power amplifier 102, thereby making it possible to move a lens to a desired position without having error at the time of driving a camera lens.

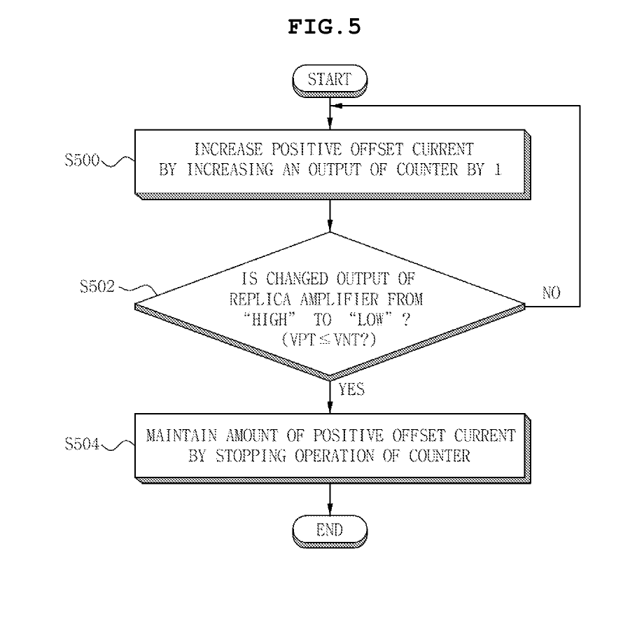

FIG. 5 is a flow chart for describing an offset cancellation method according to an exemplary embodiment of the present disclosure.

The offset cancellation method according to an exemplary embodiment of the present disclosure shown in FIG. 5 includes an operation S500 of applying a positive offset compensating current IOP which is increased by a predetermined amount to a power amplifier 102 that forcibly generates an offset and a replica amplifier 104, which is the same replica amplifier as the power amplifier, outputting an offset compensation determining signal Vout2, an operation of determining whether or not a voltage level of the offset compensation determining signal Vout2 is changed from an initial “high” level to a “low” level, wherein S500 is again performed in the case in which the voltage level of the offset compensation determining signal Vout2 is not changed from the initial “high” level to the “low” level, and an operation S504 of intactly maintaining a current amount of the positive offset compensating current IOP of a time point in which the voltage level of the offset compensation determining signal Vout2 is changed in the case in which the voltage level of the offset compensation determining signal Vout2 is changed from the initial “high” level to the “low” level.

In S500, the count code ([D6:D0]), which is the output of the 7 bit counter 110 at the time of the power on, is all in a “low” state, that is, 0 at the initial, and is increased by 1 at a rising edge (positive edge) of a clock signal CLK.

If the digital code ([D6:D0]) of 7 bits, which is the output of the 7 bit counter 110 is increased by 1, the positive offset compensating current IOP, which is the output of the 7 bit digital-to-analog converter 108 is also gradually increased.

In S502, the gate voltages VNT and VPT of the transistors M2 and M3 of the input stage of the replica amplifier 104 are compared with each other by the replica amplifier 104.

If the ratios of the widths and the lengths of the gates of the transistors

M2 and M3 of the input stage of the replica amplifier 104 is set to (W/L)_{M2}<(W/L)_{M3}, that is, the ratio ((W/L)_{M2}) of the width and the length of the gate of the transistor M2 is set to be smaller than the ratio ((W/L)_{M3}) of the width and the length of the gate of the transistor M3, the gate voltage VPT of the transistor M3 at the initial at the time of the power on becomes larger than the gate voltage VNT of the transistor M2 (i.e., VPT>VNT), such that the offset compensation determining signal Vout2 output from the replica amplifier 104 becomes initially a “high” level state.

However, as shown in FIG. 4, if the count code ([D6:D0]), which is the output of the counter 110, is increased by 1, the gate voltage VPT of the transistor M3 is gradually decreased, such that the offset compensation determining signal Vout2 output from the replica amplifier 104 at a predetermined time point t1 is changed from the initial “high” level to the “low” level.

In S504, the time point t1 in which the voltage level of the offset compensation determining signal Vout2 is changed from an initial “high” level to a “low” level may be determined as a time point in which the offset voltage is compensated and removed.

The 7 bit counter 110 stops the counting until a power-on-reset (POR) signal again becomes the “low”, that is, a power on state is continuously maintained and outputs the same count code.

Therefore, in the case in which the voltage level of the offset compensation determining signal Vout2 is changed from the “high” level to the “low” level, the 7 bit digital-to-analog converter 108 intactly maintains and outputs the positive offset compensating current IOP depending on the count code output from the counter 110.

If the positive offset compensating current IOP of the time point t1 in which the voltage level of the offset compensation determining signal Vout2 is changed from the “high” level to the “low” level is intactly maintained and is applied to the drain of the transistor M4 of the input stage of the power amplifier 102, the offset voltage generated at the time of manufacturing the semiconductor as well as the offset which is forcibly generated may be compensated and canceled.

In the offset cancellation apparatus and method according to the exemplary embodiments of the present disclosure, since whether or not the offset is compensated is determined by using the replica amplifier, which is the replica amplifier having the same structure and characteristic as the power amplifier, whether or not the offset is compensated may be accurately determined and additional switches for sensing the offset are not required, and since the configuration is simple and the operation for canceling the offset is simple, the offset may be rapidly canceled.

In addition, in the voice coil motor driver including the offset cancellation apparatus according to the exemplary embodiment of the present disclosure, since the configuration is simple and the offset may be rapidly canceled by using the same replica amplifier as the power amplifier, the lens may be moved to the desired position without having error at the time of driving the camera lens by canceling the influence of the offset current on the current flowing in the voice coil motor generated by the offset voltage of the power amplifier.

Although the embodiments of the present disclosure have been disclosed for illustrative purposes, it will be appreciated that the present disclosure is not limited thereto, and those skilled in the art will appreciate that various modifications, additions and substitutions are possible, without departing from the scope and spirit of the disclosure.

Accordingly, any and all modifications, variations or equivalent arrangements should be considered to be within the scope of the disclosure, and the detailed scope of the disclosure will be disclosed by the accompanying claims.

What is claimed is:

1. An offset cancellation apparatus comprising:
a power amplifier forcibly generating an offset;
a replica amplifier, which is the same replica amplifier as the power amplifier, having a non-inverting input terminal and an inverting input terminal connected to a non-inverting input terminal and an inverting input terminal, respectively, of the power amplifier and outputting an offset compensation determining signal; and
an offset compensating unit applying an offset compensating current to the power amplifier and the replica amplifier based on the offset compensation determining signal.

2. The offset cancellation apparatus of claim 1, wherein a ratio of a width and a length of a gate of a transistor connected to the inverting input terminal of each of the power amplifier and the replica amplifier is different from a ratio of a width and a length of a gate of a transistor connected to the non-inverting input terminal in order to forcibly generate the offset.

3. The offset cancellation apparatus of claim 2, wherein the ratio of the width and the length of the gate of the transistor connected to the inverting input terminal of each of the power amplifier and the replica amplifier is smaller than the ratio of the width and the length of the gate of the transistor connected to the non-inverting input terminal in order to forcibly generate the offset.

4. The offset cancellation apparatus of claim 3, wherein the replica amplifier outputs the offset compensation determining signal including a “high” or “low” level signal, which is a logic signal, by comparing a voltage applied to the gate of the transistor connected to the non-inverting input terminal of the input stage with a voltage applied to the gate of the transistor connected to the inverting input terminal.

5. The offset cancellation apparatus of claim 4, wherein the offset compensating unit applies an offset compensating current which is gradually increased to the transistor connected to the non-inverting input terminal of the input stage of each of the power amplifier and the replica amplifier.

6. The offset cancellation apparatus of claim 5, wherein the replica amplifier outputs the offset compensation determining signal of the “high” level at the time of power on,
in the case in which the offset compensating current is increased, such that the voltage of the gate of the transistor connected to the non-inverting input terminal of the input stage of the replica amplifier is the voltage or less of the gate of the transistor connected to the inverting input terminal, the offset compensation determining signal is changed from the “high” level to the “low” level, and
in the case in which the offset compensation determining signal is changed from the “high” level to the “low” level, the offset compensating unit maintains a current amount of the offset compensating current of a time point in which the offset compensation determining signal is changed from the “high” level to the “low” level, until a power on state is maintained.

7. The offset cancellation apparatus of claim 6, wherein the offset compensating unit applies a fixed offset current to the transistor connected to the inverting input terminal of the input stage of each of the power amplifier and the replica amplifier.

8. The offset cancellation apparatus of claim 7, wherein the offset compensating unit includes:
a counter starting a counting depending on a clock signal and a power-on-reset (POR) signal which are input so as to output an increased count code and stopping the counting until the power on state is maintained in the case in which the offset compensation determining signal is in the “low” level indicating a stop of an offset compensation; and
a digital-to-analog converter outputting the fixed offset current and outputting the offset compensating current depending on the count code output from the counter.

9. The offset cancellation apparatus of claim 8, wherein the digital-to-analog converter includes a current mirror circuit receiving the increased count code from the counter and outputting the offset compensating current which is gradually increased.

10. A voice coil motor driver including an offset cancellation apparatus, the voice coil motor driver comprising:
a power amplifier outputting a voice coil motor driving signal by receiving a signal output from a current digital-to-analog converter and forcibly generating an offset;
an input resistor connected between a non-inverting input terminal of the power amplifier and a ground;
a replica amplifier, which is the same replica amplifier as the power amplifier, having a non-inverting input terminal and an inverting input terminal connected to the non-inverting input terminal and an inverting input terminal, respectively, of the power amplifier and outputting an offset compensation determining signal;
an offset compensating unit applying an offset compensating current to the power amplifier and the replica amplifier based on the offset compensation determining signal;
a driver transistor allowing a current to flow in a voice coil motor depending on an output of the power amplifier; and
a feedback resistor connected between the driver transistor and the ground and applying a feedback voltage to the power amplifier.

11. The voice coil motor driver of claim 10, wherein a ratio of a width and a length of a gate of a transistor connected to the inverting input terminal of each of the power amplifier and the replica amplifier is different from a ratio of a width and a length of a gate of a transistor connected to the non-inverting input terminal in order to forcibly generate the offset.

12. The voice coil motor driver of claim 11, wherein the ratio of the width and the length of the gate of the transistor connected to the inverting input terminal of each of the power amplifier and the replica amplifier is smaller than the ratio of the width and the length of the gate of the transistor connected to the non-inverting input terminal in order to forcibly generate the offset.

13. The voice coil motor driver of claim 12, wherein the replica amplifier outputs the offset compensation determining signal including a “high” or “low” level signal, which is a logic signal, by comparing a voltage applied to the gate of the transistor connected to the non-inverting input terminal of the input stage with a voltage applied to the gate of the transistor connected to the inverting input terminal.

14. The voice coil motor driver of claim 13, wherein the offset compensating unit applies an offset compensating current which is gradually increased to the transistor connected to the non-inverting input terminal of the input stage of each of the power amplifier and the replica amplifier.

15. The voice coil motor driver of claim 14, wherein the replica amplifier outputs the offset compensation determining signal of the “high” level at the time of power on,
in the case in which the offset compensating current is increased, such that the voltage of the gate of the transistor connected to the non-inverting input terminal of the input stage of the replica amplifier is the voltage or less of the gate of the transistor connected to the inverting input terminal, the offset compensation determining signal is changed from the “high” level to the “low” level, and
in the case in which the offset compensation determining signal is changed from the “high” level to the “low” level, the offset compensating unit maintains a current amount of the offset compensating current of a time point in which the offset compensation determining signal is changed from the “high” level to the “low” level, until a power on state is maintained.

16. The voice coil motor driver of claim 15, wherein the offset compensating unit applies a fixed offset current to the transistor connected to the inverting input terminal of the input stage of each of the power amplifier and the replica amplifier.

17. The voice coil motor driver of claim 16, wherein the offset compensating unit includes:
a counter starting a counting depending on a clock signal and a power-on-reset (POR) signal which are input so as to output an increased count code and stopping the counting until the power on state is maintained in the case in which the offset compensation determining signal is in the “low” level indicating a stop of an offset compensation; and
a digital-to-analog converter outputting the fixed offset current and outputting the offset compensating current depending on the count code output from the counter.

18. The voice coil motor driver of claim 17, wherein the digital-to-analog converter includes a current mirror circuit receiving the increased count code from the counter and outputting the offset compensating current which is gradually increased.

19. An offset cancellation method comprising:
(A) an operation of applying a offset compensating current which is increased by a predetermined amount to a power amplifier that forcibly generates an offset and a replica amplifier, which is the same replica amplifier as the power amplifier, having a non-inverting input terminal and an inverting input terminal connected to a non-inverting input terminal and an inverting input terminal, respectively, of the power amplifier and outputting an offset compensation determining signal;
(B) an operation of determining whether or not a voltage level of the offset compensation determining signal is changed from an initial level to another level, wherein the operation (A) is again performed in the case in which the voltage level of the offset compensation determining signal is not changed from the initial level to another level; and
(C) an operation of intactly maintaining a current amount of the offset compensating current of a time point in which the voltage level of the offset compensation determining signal is changed from the initial level to another level in the case in which the voltage level of the offset compensation determining signal is changed from the initial level to another level.

20. The offset cancellation method of claim 19, wherein a ratio of a width and a length of a gate of a transistor to which a signal from the inverting input terminal of each of the power amplifier and the replica amplifier is input is different from a ratio of a width and a length of a gate of a transistor to which a signal from the non-inverting input terminal is input in order to forcibly generate the offset.
